(19) United States
(12) Patent Application Publication
(10) Pub. No.: US 2007/0207256 A1
(43) Pub. Date: Sep. 6, 2007

(54) Synthetic biodegradable northern quahog shell for food preparation, food presentation, and food storgae

(76) Inventor: Chad D. Clement, East Falmouth, MA (US)

Correspondence Address: Russ Weinzimmer, 614 Nashua Street #204, Milford, NH, 03055, US

(21) Appl. No.: 11/713,494

(22) Filed: Mar. 2, 2007

Related U.S. Application Data
(60) Provisional application No. 60/778,177, filed on Mar. 2, 2006.

(51) Int. Cl. A23L 1/325; A23G 3/02

(52) U.S. Cl. 426/643; 426/512

(57) ABSTRACT

A simulation of a Northern Quahog shell is provided for use in preparing, serving, and/or storing food. The shell is made from biodegradable materials, and includes two half-shells joined together by a functioning hinge portion. The shell also includes alignment notches so as to assure a perfectly aligned and tight closure, also bearing realistic growth rings, and realistic texture and coloring inside and outside the shells. The shell is made of materials suited to withstand handling, stuffing, baking, microwaving, and freezing, without material fatigue or distortion, and can be uniformly manufactured to assure consistent product size, ease of production, cleanliness, light weight, and improved durability. The shells are a one-time-use, consumable product. The shell is of natural color, using no dyes or inks. In use, the shell can contain food stuffing, which can be fully enclosed by the shell. The shell can be made from sugar cane stalk.

### CROSS-REFERENCE TO RELATED APPLICATION

This application is entitled to the benefit of U.S. Provisional Patent Application No. 60/778,177, entitled “MAN MADE MOLDED/CASTED BIODEGRADABLE/COMPOSTALBE NORTHERN QUAHOG SHELL (MERCENARIA MERCENARIA) MADE FOR BAKING PURPOSES, FOOD STUFFING AND FOOD INDUSTRY”, filed Mar. 2, 2006, herein incorporated by reference.

### FIELD OF THE INVENTION

This invention relates to apparatus for food preparation, food presentation, and food storage, and particularly to such apparatus shaped like a natural shell.

### BACKGROUND OF THE INVENTION

Many different problems can arise for those involved in the stuffed quahog (stuffed clam) business. When purchasing fresh natural quahogs (the coastal mollusk Mercenaria Mercenaria) (also known as Venus Mercenaria) (also known as the common Atlantic Quahog) (also called “chowder quahogs”, the largest grade of quahog) at the fish wholesaler, one buys the quahogs in bushel bags. In most cases, however, the shells of the quahogs are too large for making stuffed quahogs for sale, because such shells can contain too much stuffing, resulting in lost profits. Additionally, large stuffed quahog shells take too long to cook. Conversely, smaller chowder quahog shells are found that are too small, and consequently do not contain enough stuffing to meet the standards of the restaurant industry. Therefore, most of the quahogs found in the typical bushel bags are not usable due to unsuitable shell size.

Even natural quahog shells of proper size for the restaurant industry are problematic. For example, such shells are brittle, and frequently break. Further, properly-sized natural quahog shells are not always readily available. Moreover, properly sized natural quahog shells are labor-intensive to use for making stuffed shells, and are often unsanitary. In addition, not all natural quahog shells look good on the inside of the shell. For example, some may look not appropriate for serving food because of ugly staining, spalling (chipping), or deterioration of the shell.

### SUMMARY OF THE INVENTION

The invention is a molded and/or casted simulation of a Northern Quahog (Mercenaria Mercenaria) shell. In a preferred embodiment, the shell of the invention is made from health guideline biodegradable and/or compostable natural resource materials. The invention can be advantageously used for baking and/or stuffing, and for storage purposes in the food industry. The shell of the invention effectively simulates a real Northern Quahog shell. For example, the shell of the invention includes two half shells, the two half shells being joined together by a functioning hinge portion. The shell of the invention also includes alignment notches so as to assure a perfectly aligned and tight closure.

The outer surface of the shell of the invention also includes realistic-looking growth rings, as well as realistic texture and coloring inside and outside the shells, thereby simulating the overall appearance of a real Quahog shell.

The shell of the invention is made of materials suited to withstand handling, stuffing, baking, microwaving, and freezing, without material fatigue or distortion. The shell of the invention can be uniformly manufactured so as to assure consistent product size, ease of production, cleanliness, light weight, and more durability. Consequently, the shell of the invention is more consistent in size, more easy to produce, more sanitary, lighter in weight, and more durable than real Quahog shells as found in nature.

The shell of the invention thus resolves the shell-size problem of the prior art because they can be made in a uniform manner. Consequently, any size Quahog can be purchased for the edible meat inside, and the meat can be used to make stuffing that can be used immediately, or stored in the shell of the invention for use at a later time.

The shells of the invention are modeled after real Quahog shells, having authentic convex shaping and growth ring grooves. The shells of the invention are also biodegradable/compostable, which make them environmentally friendly. The shells of the invention are a one-time-use, consumable product. A consumer buys the shell of the invention with the stuffing in the shell, and can store it in a refrigerator or freezer, heat it, eat its contents, and then throw the shell away. The shells of the invention are made by a thermoforming process, which is a practice of forming raw material into a shape from natural, light-weight renewable resource materials, such as sugar cane stalk pulp. The weight of the synthetic shell of the invention is considerably lighter than a real Quahog shell, making it cost effective to ship via ground or air transport. The shell of the invention is of natural color, using no dyes or inks. The shell has two half shells joined together by a fully functioning hinge, just like a real quahog shell, and is made of a natural biodegradable material.

In use, the shell of the invention can contain food stuffing, which can be fully enclosed by the two halves of the shell when in a closed position. When closed and placed in an oven, the quahog shell of the invention creates an enclosure to help prevent drying out or burning of the stuffing. When closed and placed in a freezer for a prolonged period, the quahog shell of the invention helps prevent freezer burn. The quahog shell of the invention can withstand temperatures in an oven of up to 220 degrees Celsius, and in a freezer down to −25 degrees Celsius, without material fatigue or distortion.

Also, the quahog shell of the invention does not bear any ugly staining, spalling (chipping), or deterioration of the shell, resulting in a more pleasing visual presentation.

A first general aspect of the invention is a synthetic biodegradable Northern Quahog shell. The shell includes a top half shell made of biodegradable material, and having a hinge portion, and a bottom half shell made of biodegradable material, and having a hinge portion, the top hinge portion and the bottom hinge portion being cooperative to enable the shell to hingedly close.

In a preferred embodiment, the top half shell further has a top alignment notch, and the bottom half shell further has a bottom alignment notch, the top alignment notch and the bottom alignment notch being cooperative to ensure that the top half shell closes in alignment with the bottom half shell.

In other preferred embodiments, the top half shell bears realistic growth ring grooves on an outer surface. In further preferred embodiments, the bottom half shell bears realistic growth ring grooves on an outer surface.

In some other preferred embodiments, the biodegradable material is selected and formed to have texture and coloring resembling a natural quahog shell.

In yet other preferred embodiments, the shell is of a consistent size among a plurality of such shells.

In preferred embodiments, the shell being made by: taking a 3-D picture of a real quahog shell; converting the 3-D picture into a CAD model; using CAD software to create a mold from the CAD model; and using the mold to form the shell.

In additional preferred embodiments, the shell is made from a biodegradable material that is capable of withstanding both high temperatures and low temperatures at least without material fatigue and shape distortion.

In further preferred embodiments, the shell is intended to be used once and then discarded. In yet further preferred embodiments, the shell is made from sugar cane stalk pulp. In still further preferred embodiments, the shell is made using a thermoforming process. In other preferred embodiments, the shell is made from a renewable resource material.

In preferred embodiments, the shell is made from a material that results in the shell being lighter than a typical quahog shell.

In preferred embodiments, the shell is free of any dye and ink.

In further preferred embodiments, the top hinge portion and the bottom hinge portion are made from the same material as the top half shell and the bottom half shell.

In other preferred embodiments, the top half shell and the bottom half shell are shaped so as to be capable of enclosing food stuffing so as to help prevent drying out or burning of the stuffing when cooked and stored in a freezer.

In yet other preferred embodiments, the top half shell and the top hinge are made from same material and included in same mold.

Another general aspect of the invention is a synthetic biodegradable Northern Quahog shell, where the shell includes: a top half shell made of biodegradable material, and having a top hinge portion and a top alignment notch, and bearing realistic growth ring grooves on a top outer surface; a bottom half shell made of biodegradable material, and having a bottom hinge portion and a bottom alignment notch, and bearing realistic growth ring grooves on a bottom outer surface, the top half shell and the bottom half shell being cooperative to enable the shell to hingedly close so as to substantially enclose any food stuffing contained therein.

In preferred embodiments, the top half shell bears realistic growth ring grooves on an outer surface, and the bottom half shell bears realistic growth ring grooves on an outer surface.

In other preferred embodiments, the biodegradable material is selected and formed to have texture and coloring resembling a natural quahog shell, and is capable of withstanding both high temperatures and low temperatures at least without material fatigue and shape distortion.

### BRIEF DESCRIPTION OF THE DRAWINGS

The invention will be more fully understood by reference to the detailed description, in conjunction with the following figures, wherein:

FIG. 1 shows a top view of two half shells of the invention, joined by a hinge, each half shell having alignment notches;

FIG. 2 shows a bottom view of the two half shells of FIG. 1, the hinge being visible, also showing simulated growth rings;

FIG. 3 shows the shell of the invention in a closed position, the outer shell bearing texture and coloring of a real quahog; and

FIG. 4 shows two half shells of the invention in an open position, one shell containing a standard quantity of stuffing.

### DETAILED DESCRIPTION

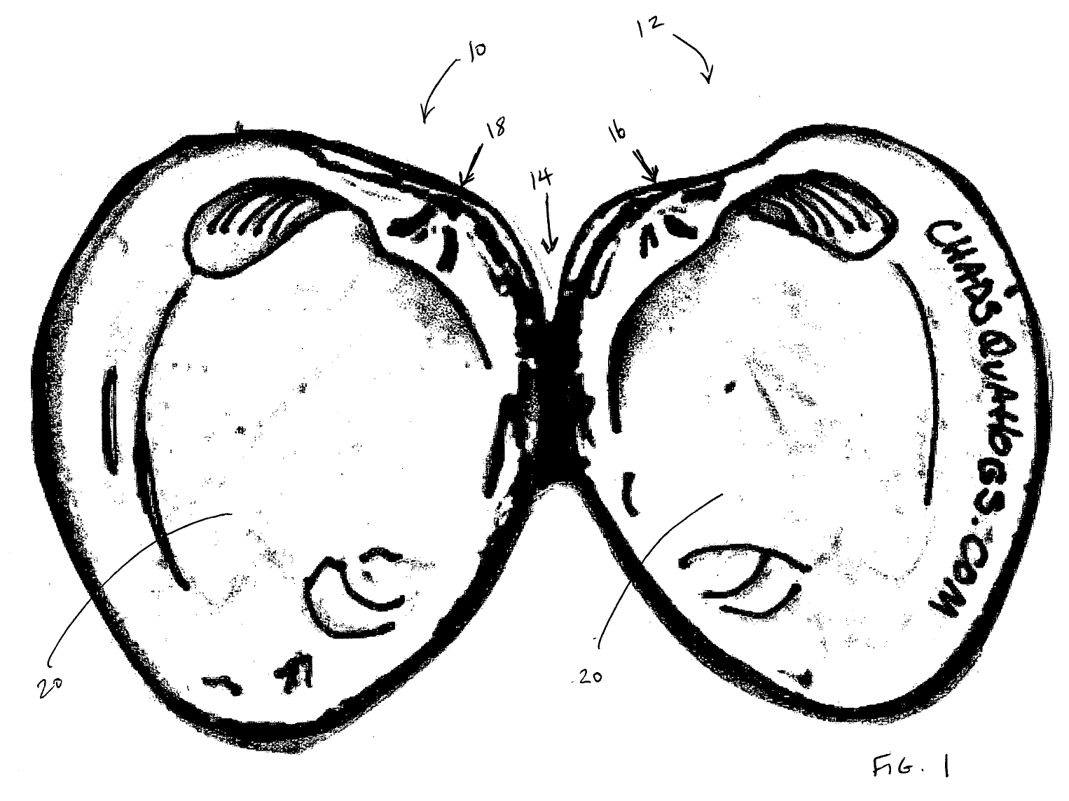

With reference to FIG. 1, a top view of the shell of the invention is shown having a a top half shell 10 made of biodegradable material, and bottom half shell 12, also made of biodegradable material. Each of the half shells 10 and 12 have a hinge portion, the hinge portions cooperating 14 so as to enable the shell 10, 12 to hingedly close.

To maintain the shell in proper alignment when the shell is closed, alignment notches 16 and 18 are mutually engaged upon closing of the shell 10, 12.

The inside of the shell 20 is of a color and texture that resembles a real shell, partly due to the biodegradable material used, and partly due to the processed used to mold the material, as will be further described below.

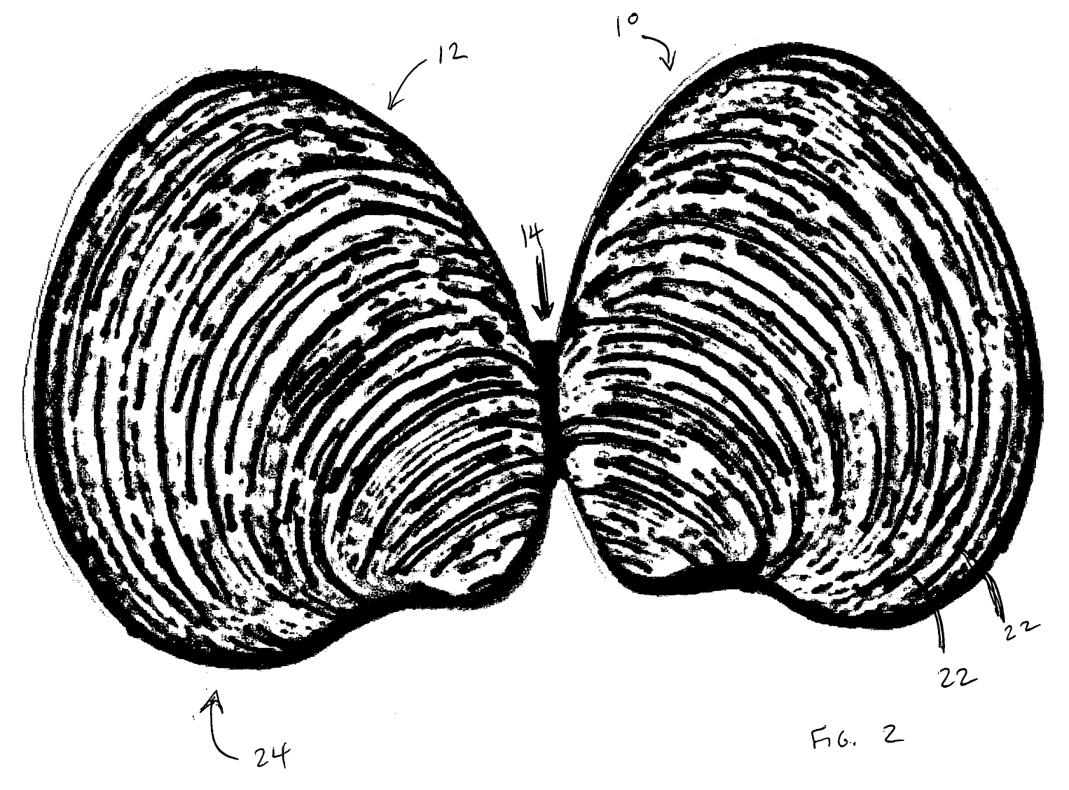

Referring to FIG. 2, a bottom view of the shell shown in FIG. 1 is presented. Note that the hinge portions are shown cooperating 14, hingedly joining the top half shell 10 to the bottom half shell 12. Visible in this view are the growth rings 22 that resemble the growth rings found naturally on the outer surface of quahog shells. The rest of the outer surface 24 of the shell halves also strongly resembles the texture, shape, and coloring of natural quahog shells.

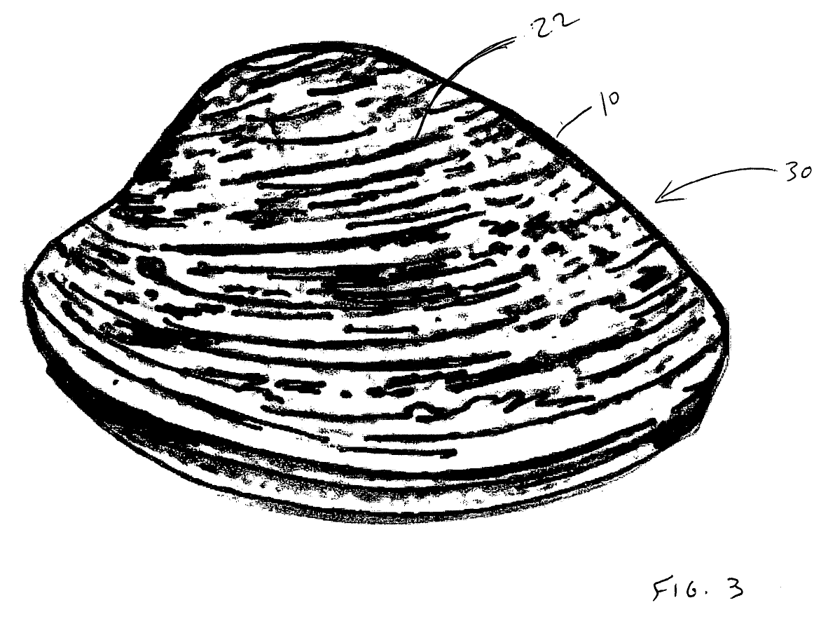

Referring to FIG. 3, the shell of the invention is shown in the closed position so that the top half shell 10 is visible, again also showing the growth rings 22 that give the shell an authentic natural appearance. The shell also bears the same color, texture, and shape of a natural quahog shell 30.

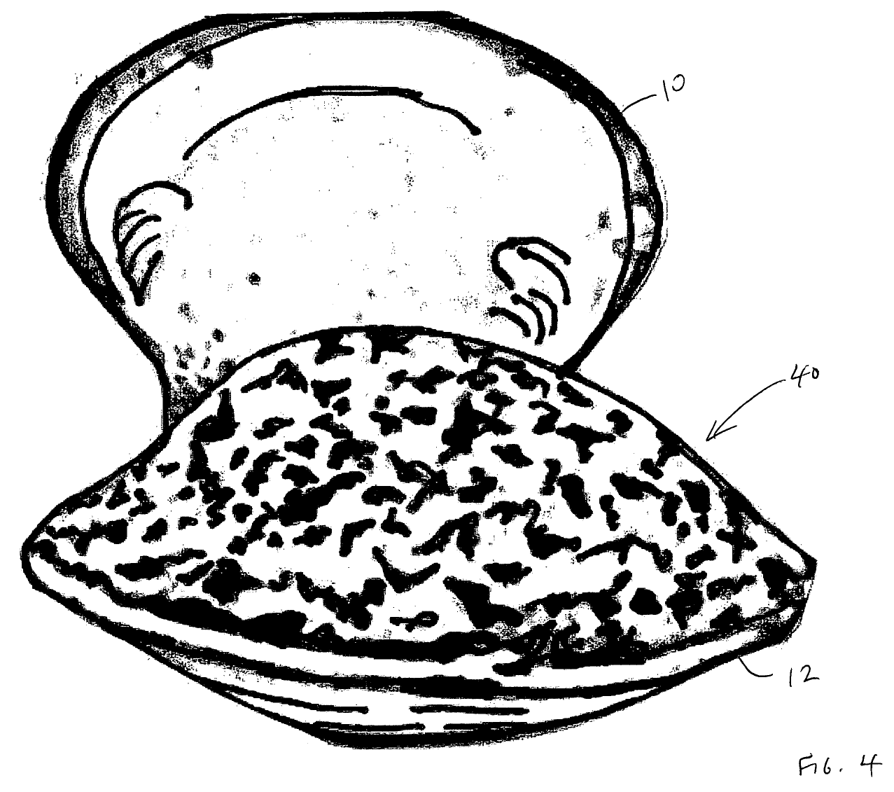

With reference to FIG. 4, the shell shows the shell open, and containing a quantity of food stuffing 40. The top half shell 10 is hingedly held in a generally upright position, while the bottom half shell 12 rests on a supporting surface, also supporting the food stuffing 40. The top shell 10 can be hingedly closed so that it effectively forms a seal with the bottom half shell 12, thereby protecting the food stuffing from drying out, and/or from excessive heat when cooked in an oven.

Food stuffing can also be stored in the shell of the invention, and when that shell is closed, the food stuffing inside is somewhat protected from drying out in the freezer.

The shell of the invention is preferably made using “thermoforming”. Thermoforming is a method for forming materials by means of heat and pressure. The biodegradable shell of the invention is made from sugar cane dregs, or stalks that are cut, ground, and made into a slurry with water. The slurry is then formed into a raw material, similar to sheets of paper. Raw materials could vary in different applications. For example, straw, palm tree leaves, wheat, potato, corn, tapioca starches have also been used in thermoforming techniques. The shell of the invention is made from sugar cane, which is much more durable, and more heat-resistant, and resistant to water and oil than any of the other materials listed herein.

The high-density cellular properties of sugar cane stalks make them very desirable for making the shell of the invention. After the raw material is made, it is then placed over a form mold which can be made from various metals, such as copper or stainless steel. To make the shell of the invention, the mold is machined to look like an authentic quahog shell. Quahog shells have growth bands on the exterior part of the shell similar to growth rings in a tree, but they are on the exterior of each shell half. The mold incorporates these growth rings (or grooves) so that the shell looks substantially like a real quahog shell.

Also, the mold includes a replication of a quahog shell hinge. Quahogs have hinge so they can open and close, and hingedly keep the two half shells together. The molded biodegradable shell of the invention uses the hinge for hingedly joining the two halves together so as to form a full enclosure for food stuffing that can be placed therein. The hinge, growth grooves (or rings), and shape of shell, are all integral parts of the mold. The raw material (e.g., sugar cane slurry) is placed in the mold, and with heat and pressure, are formed into a replicated quahog shell. After it is molded, the shell of the invention is then sent to a cut mold that trims off any excess raw material.

Sometimes, the quahogs of the invention are stuffed and sold fresh and un-frozen to consumers, making the shells susceptible to shipping and/or handling damage, such as shell alignment shifting, which may impair the tight enclosure for the food product. The alignment notches on the biodegradable quahog shell of the invention function to help maintain substantial alignment of the two shell halves of the quahog shell of the invention. After food stuffing has been put in the shell and the shell is closed, the alignment notches inhibit the two shell halves from shifting from side to side when stored in an un-frozen state. In some cases, the stuffed quahog shell of the invention is stuffed and frozen immediately, thereby making the two shell halves less susceptible to shifting, because the frozen food stuffing substantially maintains the two shell halves in alignment.

The natural color of the raw material used to make the quahog shell of the invention is a light tan to almost white. Real quahog shells vary in color, depending what type of soil they live in. For example, tan-white quahogs are commonly found. Therefore, it is not necessary to use any paints, dyes, or inks. Thus, it is possible to make the quahog shell of the invention from material that is 100 percent natural and Earth-friendly. It is also possible to use a 100% natural and food-grade dye to make the quahog shells of the invention more brown-grey, which can also be commonly found in nature. Quahog shells of the invention made using the thermoforming technique described herein bear a substantial resemblance to quahog shells found in nature. This is accomplished by first taking 3-D pictures of a real quahog shell, and then converting the 3-D pictures into a CAD model. The CAD model and CAD software is then used to fabricate a mold, using methods well-known to those skilled in the art of CAD/CAM.

Other modifications and implementations will occur to those skilled in the art without departing from the spirit and the scope of the invention as claimed. Accordingly, the above description is not intended to limit the invention except as indicated in the following claims.

What is claimed is:

1. A synthetic biodegradable Northern Quahog shell, the shell comprising:
a top half shell made of biodegradable material, and having a hinge portion; and
a bottom half shell made of biodegradable material, and having a hinge portion, the top hinge portion and the bottom hinge portion being cooperative to enable the shell to hingedly close.

2. The shell of claim 1, the top half shell further having a top alignment notch, and the bottom half shell further having a bottom alignment notch, the top alignment notch and the bottom alignment notch being cooperative to ensure that the top half shell closes in alignment with the bottom half shell.

3. The shell of claim 1, wherein the top half shell bears realistic growth ring grooves on an outer surface.

4. The shell of claim 1, wherein the bottom half shell bears realistic growth ring grooves on an outer surface.

5. The shell of claim 1, wherein the biodegradable material is selected and formed to have texture and coloring resembling a natural quahog shell.

6. The shell of claim 1, wherein the shell is of a consistent size among a plurality of such shells.

7. The shell of claim 1, the shell being made by:
taking a 3-D picture of a real quahog shell;
converting the 3-D picture into a CAD model;
using CAD software to create a mold from the CAD model; and
using the mold to form the shell.

8. The shell of claim 1, wherein the shell is made from a biodegradable material that is capable of withstanding both high temperatures and low temperatures at least without material fatigue and shape distortion.

9. The shell of claim 1, wherein the shell is intended to be used once and then discarded.

10. The shell of claim 1, wherein the shell is made from sugar cane stalk pulp.

11. The shell of claim 1, wherein the shell is made using a thermoforming process.

12. The shell of claim 1, wherein the shell is made from a renewable resource material.

13. The shell of claim 1, wherein the shell is made from a material that results in the shell being lighter than a typical quahog shell.

14. The shell of claim 1, which shell is free of any dye and ink.

15. The shell of claim 1, wherein the top hinge portion and the bottom hinge portion are made from the same material as the top half shell and the bottom half shell.

16. The shell of claim 1, wherein the top half shell and the bottom half shell are shaped so as to be capable of enclosing food stuffing so as to help prevent drying out or burning of the stuffing when cooked and stored in a freezer.

17. The shell of claim 1, wherein the top half shell and the top hinge are made from same material and included in same mold.

18. A synthetic biodegradable Northern Quahog shell, the shell comprising:
a top half shell made of biodegradable material, and having a top hinge portion and a top alignment notch, and bearing realistic growth ring grooves on a top outer surface; and
a bottom half shell made of biodegradable material, and having a bottom hinge portion and a bottom alignment notch, and bearing realistic growth ring grooves on a bottom outer surface,
the top half shell and the bottom half shell being cooperative to enable the shell to hingedly close so as to substantially enclose any food stuffing contained therein.

19. The shell of claim 18, wherein the top half shell bears realistic growth ring grooves on an outer surface, and the bottom half shell bears realistic growth ring grooves on an outer surface.

20. The shell of claim 18, wherein the biodegradable material is selected and formed to have texture and coloring resembling a natural quahog shell, and is capable of withstanding both high temperatures and low temperatures at least without material fatigue and shape distortion.
